(19) United States
(12) Patent Application Publication
(10) Pub. No.: US 2006/0032129 A1
(43) Pub. Date: Feb. 16, 2006

(54) Self-watering breeding device

(76) Inventor: Wen-Chi Lai, Taichung Hsien (TW)

Correspondence Address: HERSHKOVITZ & ASSOCIATES, 1725 I STREET NW, SUITE 300, WASHINGTON, DC, 20006, US

(21) Appl. No.: 11/228,260

(22) Filed: Sep. 19, 2005

Related U.S. Application Data
(63) Continuation-in-part of application No. 10/862,391, filed on Jun. 8, 2004.

(51) Int. Cl. A01G 31/00

(52) U.S. Cl. 47/62 R

(57) ABSTRACT

A self-watering breeding device has a culturing slide, a capillary sheet, and an optional immersion sheet. The culturing slide has a gradual slope, a steep slope and a guiding arc connected between the gradual slope and the steep slope. The gradual slope has multiple through holes to allow roots of seeds extending through the through holes. The capillary sheet attaches on the steep slope and extends over the guiding arc. The immersion sheet attaches on the gradual slope and partially overlaps with the capillary sheet. When the culturing slide stands on a basin full of water, the capillary sheet absorbs water and guides water over the guiding arc to reach the gradual slope. Then, water travels over the entirely immersion sheet to supply seeds on the gradual slope by gravity attraction. Additionally, exceeded water slides along the gradual slope to the basin to recycle.

### CROSS-REFERENCE TO RELATED APPLICATIONS

The present application is a continuation-in-part of application Ser. No. 10/862,391, filed on Jun. 08, 2004, the disclosure of which is expressly incorporated by reference herein in its entirety.

### BACKGROUND OF THE INVENTION

1. Field of the Invention

The present invention relates to a self-watering breeding device, and more particularly to a self-watering breeding that has a simple structure and excellently watering efficiency for evenly breeding plants.

2. Description of Related Art

Small plants or vegetable sprouts are commonly bred in house with various types of containers filled with water or plant growing materials to culture pot plants or vegetables. However, breeding the plants is troublesome because breeders have to pay a lot of attention to water the plants. Therefore, several types of self-watering breeding devices are developed to resolve the breeders' troublesome matters.

With reference to FIGS. 6 and 7, a first conventional self-watering breeding device comprises a basin (80), an optional soaping plate (82), a breeding plate (84), an immersion sheet (86) and a cover (88).

The basin (80) is a rectangular box with four sides and a bottom and has an importing port (802) defined at one side of the basin (80). The optional soaping plate (82) is accommodated inside the basin (80) and has multiple leaking holes (not numbered) defined in a bottom face of the soaping plate (82) to drain out excess water to the bottom of the basin (80). The breeding plate (84) is mounted on the soaping plate (82) to support seeds and has a watering device (85) mounted on a center of the breeding plate (84) to attract the water upward. The water device (85) is consisted of a cubic base (not numbered) with two side cutouts and a wicking sheet (not numbered) attached on a top face of the base and extended downward via the two side cutouts of the base. The immersion sheet (86) is mounted on the breeding plate (84) to contact with the wicking sheet, so that water can be further absorbed by the immersion sheet (86) to spread all over the breeding plate (84). Lastly, the cover (88) is detachably mounted on the basin (80) to close the first conventional self-watering breeding device.

However, the first conventional self-watering breeding device has high product cost because it contains several elements. Additionally, the first conventional self-watering breeding device has poor watering efficiency because parts of the immersion sheet (86) away from the watering device (85) are hard to have enough water.

With reference to FIGS. 8 and 9, a second conventional self-watering breeding device comprises a support frame (90), multiple sack-like bags (92) and multiple loose flats (922).

The support frame (90) is in form of double shaped platforms arranged side-by-side and separated by a trough (94), wherein the platforms are sloped to the trough (94). Additionally, multiple ribs (902) are formed on tops of the platforms.

The multiple sack-like bags (92) are arranged on the platforms. Each sack-like bag (92) has a wrapping (not numbered) made of wicking material and a plant growth material (not numbered) filled inside the bag.

The multiple loose flaps (922) are individually attached to the sack-like bag (92). Each loose flap (922) is a part of a lower surface forming portion of the sack-like bag and extends downwardly from the bag into the trough (94) for immersion in a liquid, such as water, water-fertilizer mixture and the like. The liquid is continuously flowed by capillary action up the loose flap (922) and along wrapping for continuous dispersion into the filler material for feeding liquid to roots of plants.

Although the second conventional self-watering breeding device has a simpler structure than the first conventional one, the second conventional self-watering breeding device still has poor watering efficiency at distal edges of the sack-like bags (92) because only rear liquid attracted by capillary force can overcome the gravity force to reach the distal edges. In addition, the aforementioned conventional self-watering breeding devices cannot allow the roots of seeds to contact and absorb water directly, so the use of the conventional self-water breeding device is limited to seeds that do not need much water for growth, for example cauliflower, but cannot be applied to seeds that need much water for growth, for example bean sprouts. Therefore, the conventional self-watering breeding device is not versatile in use.

The present invention has arisen to mitigate or obviate the drawbacks of the conventional self-watering breeding devices.

### SUMMARY OF THE INVENTION

The main objective of the present invention is to provide a self-watering breeding device that has a simple structure and is versatile in use.

The other objective of the present invention is to provide a self-watering breeding device that has an excellent watering efficiency to evenly spread liquid all over the device.

A self-watering breeding device in accordance with the present invention comprises a culturing slide, a capillary sheet and an optional immersion sheet. The culturing slide has a gradual slope, a steep slope and a guiding arc connected between the gradual slope and the steep slope. The gradual slope has multiple through holes defined through the gradual slope. The capillary sheet attaches on the steep slope and extends over the guiding arc. The immersion sheet attaches on the gradual slope and partially overlaps with the capillary sheet. When the culturing slide stands on a basin full of water, the capillary sheet absorbs water and guides water over the guiding arc to reach the gradual slope. Then, water travels over the entirely immersion sheet to supply seeds on the gradual slope by gravity attraction. Additionally, excess water slides along the gradual slope to the basin to recycle again.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a self-watering breeding device in accordance with the present invention;

FIG. 2 is an enlarged cross-sectional side plane view of the self-watering breeding device in FIG. 1, wherein the self-watering breeding device is assembled;

FIG. 3 is an operational cross-sectional side plane view of the self-watering breeding device, wherein the self-watering breeding device is accommodated inside a hothouse;

FIG. 4 is a cross-sectional side plane view of another embodiment of a self-watering breeding device in accordance with the present invention;

FIG. 5 is a cross-sectional side plane view of a further embodiment of a self-watering breeding device in accordance with the present invention;

FIG. 6 is an exploded perspective view of a first conventional self-watering breeding device in accordance with the prior art;

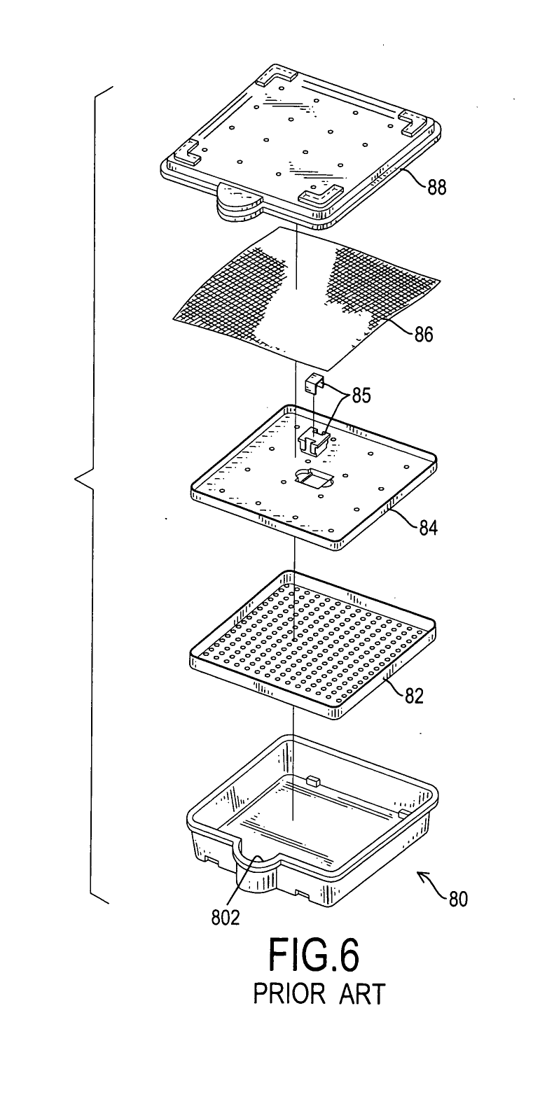

FIG. 7 is an enlarged cross-sectional side plane view of the first conventional self-watering breeding device in FIG. 6, wherein the first conventional self-watering breeding device is assembled;

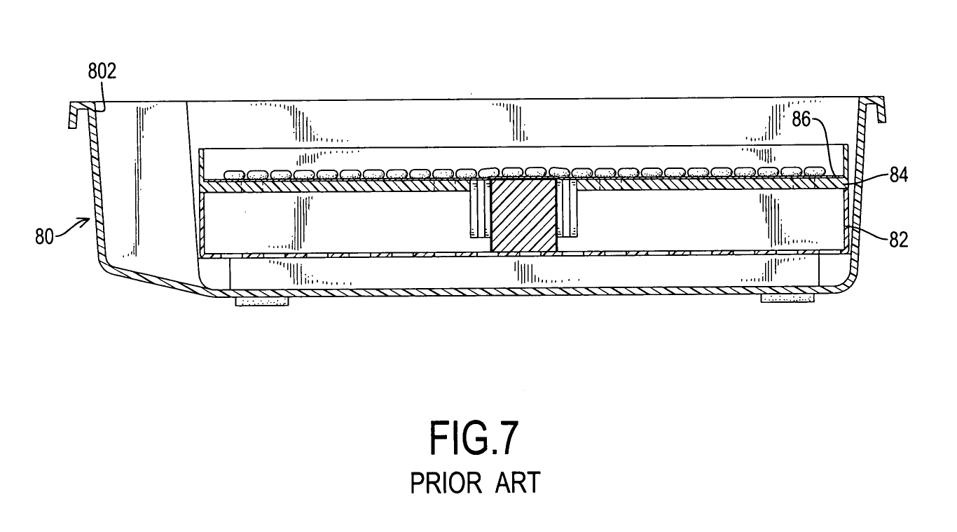

FIG. 8 is a perspective view of a second conventional self-watering breeding device in accordance with the prior art; and

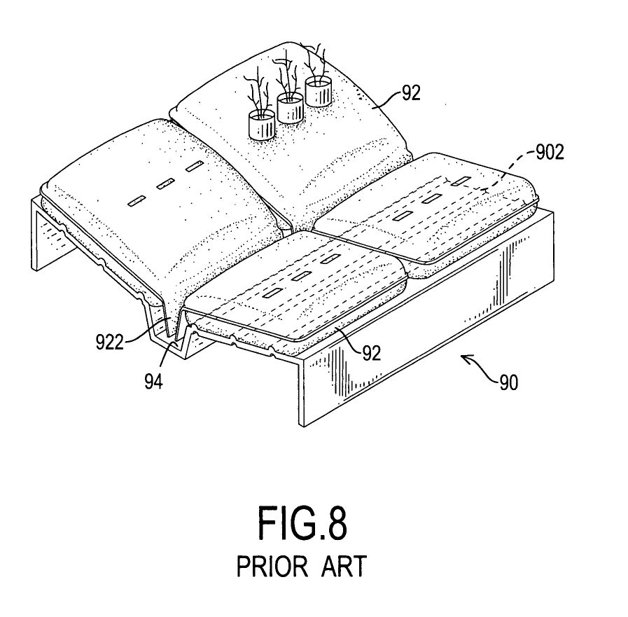

FIG. 9 is an enlarged cross-sectional side plane view of the second conventional self-watering breeding device in FIG. 8, wherein the second conventional self-watering breeding device is assembled.

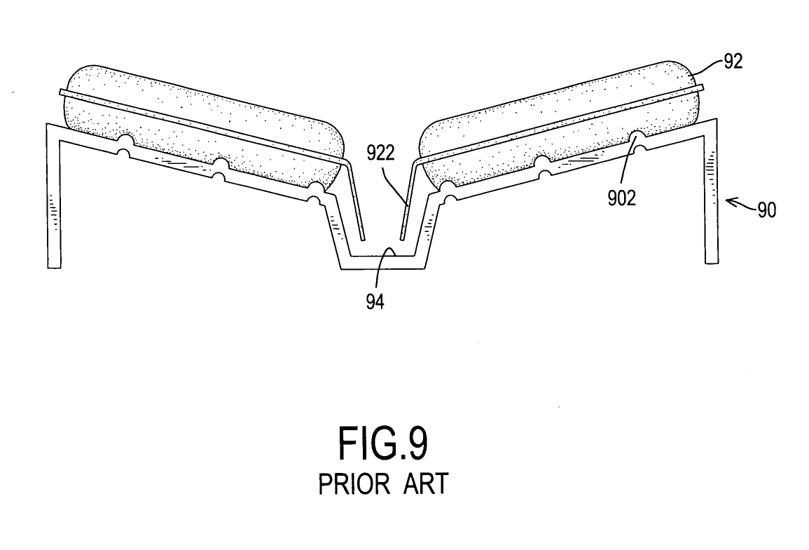

### DETAILED DESCRIPTION OF THE PREFERRED EMBODIMENT

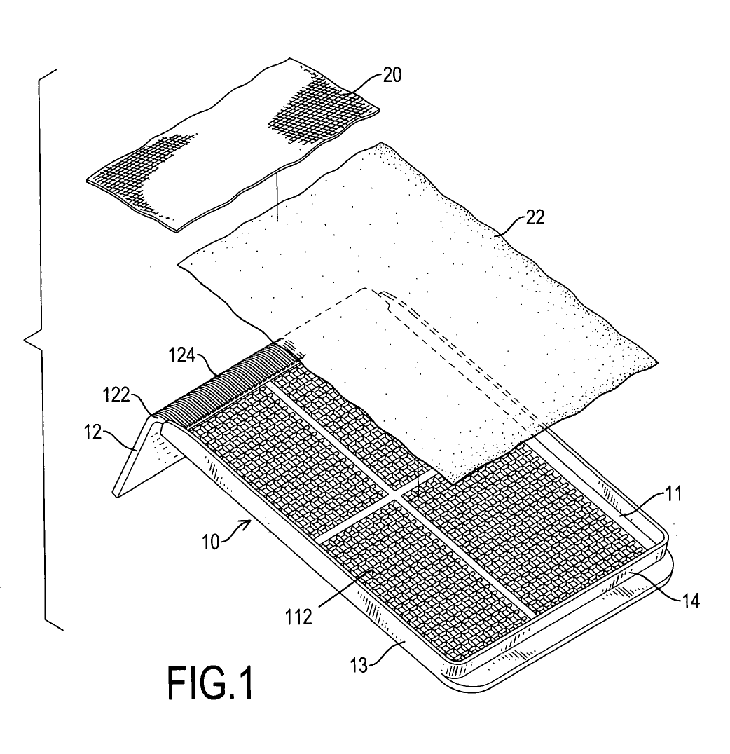

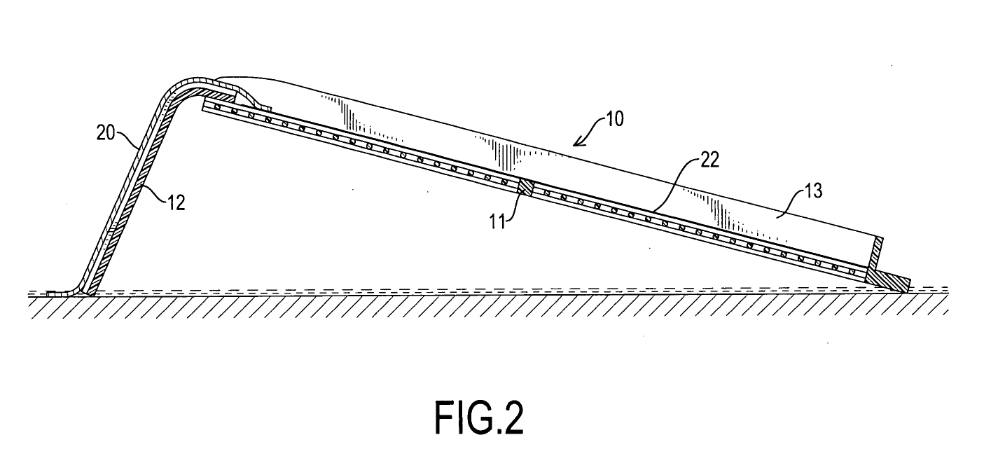

With reference to FIGS. 1 and 2, a first preferred embodiment of self-watering breeding device in accordance with the present invention comprises a culturing slide (10), a capillary sheet (20) and an immersion sheet (22).

The culturing slide (10) is a bridge with two sides and two ends and is composed a gradual slope (11), a steep slope (12) and a guiding arc (122) integrally connected between the gradual slope (11) and the steep slope (12). The culturing slide (10) further has two side boards (13) erectly formed at two sides of bridge and a bottom board (14) formed at the end at the steep slope (12). The gradual slope (11) has multiple through holes (112) defined through the gradual slope (11). Multiple guiding ribs (124) are formed over the steep slope (12) and the guiding arc (122).

The capillary sheet (20) is placed on the steep slope (12) to absorb water upward to the gradual slope (11). Preferably, the capillary sheet (20) and has a width same as that of the culturing bridge and a length longer than that of the steep slope (12). Therefore, the capillary sheet (20) enables to extend from the end of the steep slope (12) to exceed the guiding arc (122) to the gradual slope (11). In order to absorb water efficiently, the capillary sheet (20) is made of absorbent materials selected from the group of cotton cloth, non-woven cloth, sponge and paper. Preferably, the capillary sheet (20) is made of cotton cloth.

The immersion sheet (22) is placed on the gradual slope (11) to cover the entire gradual slope (11). A part of the immersion sheet (22) overlaps the exceeded capillary sheet (20) so that water can be further conducted to the gradual slope (11). The immersion sheet (22) is made of absorbent material selected from the group of cotton cloth, non-woven cloth, sponge and paper. Preferably, the capillary sheet (20) is made of cotton cloth. Preferably, the immersion sheet (22) is toilet paper or tissue paper.

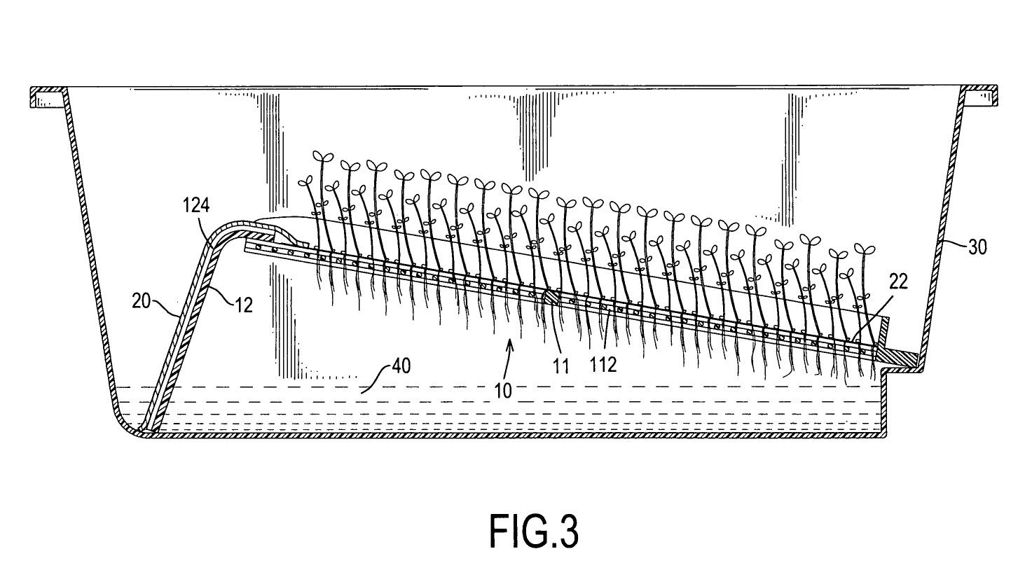

With further reference to FIG. 3, when the self-watering breeding device is in use, the culturing slide (10) stands on a basin (30) full of water (40) or fertile liquids and multiple seeds are evenly arranged on the immersion sheet (22). In practice, the end of the gradual slope (11) far away from the steep slope (12) stands on a protrusion formed on the basin (30) to change the horizontal level of the gradual slope (11). The capillary sheet (20) is partially immerged in the water to absorb water to guide water over the guiding arc (122) to reach the gradual slope (11). Then, the water automatically travels all over the entirely immersion sheet (22) to water seeds and sprouts on the gradual slope (11) by gravity attraction. Excessive water slides along the gradual slope (11) through the through holes (112) back to the basin (30) to recycle. In addition, with the arrangement of the through holes (112), roots of the breeding seeds can extend through the through holes (112) to allow the seeds absorb water directly. Accordingly, the culturing slide (10) can fit with seeds that need much water for growth, for example bean sprouts. Furthermore, with the arrangements of the guiding ribs (124), the friction between the steep slope (12) and the capillary sheet (20) is enlarged to keep the capillary sheet (20) from slipping from the steep slope (12).

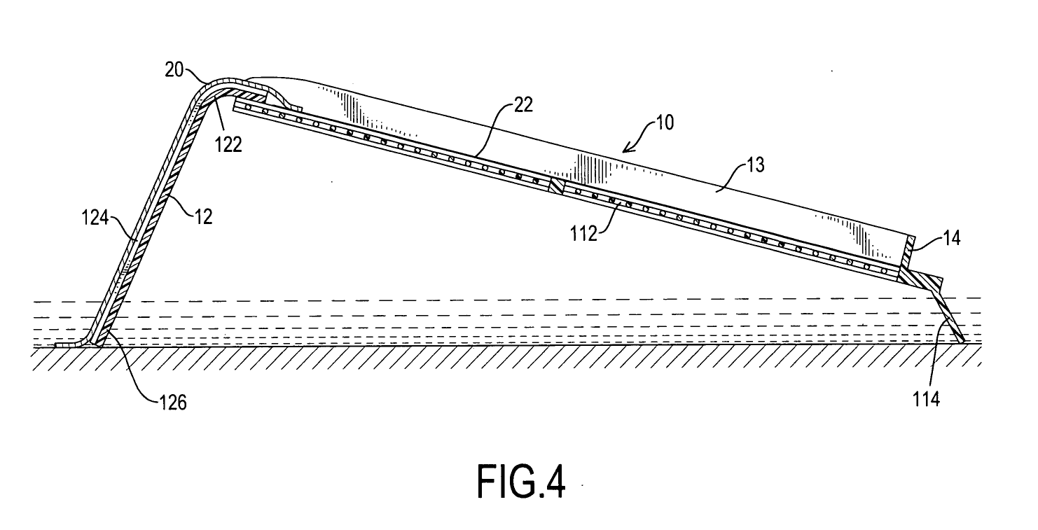

With reference to FIG. 4, a second preferred embodiment of the self-watering breeding device in accordance with the present invention has the same structure with the first embodiment except multiple extending feet (112, 124). Two extending feet (112, 124) are respectively formed at the two ends of the culturing slide (10). Thereby, the culturing slide (10) is raised to allow more water stored inside the basin. Therefore, breeders do not have to add water so often.

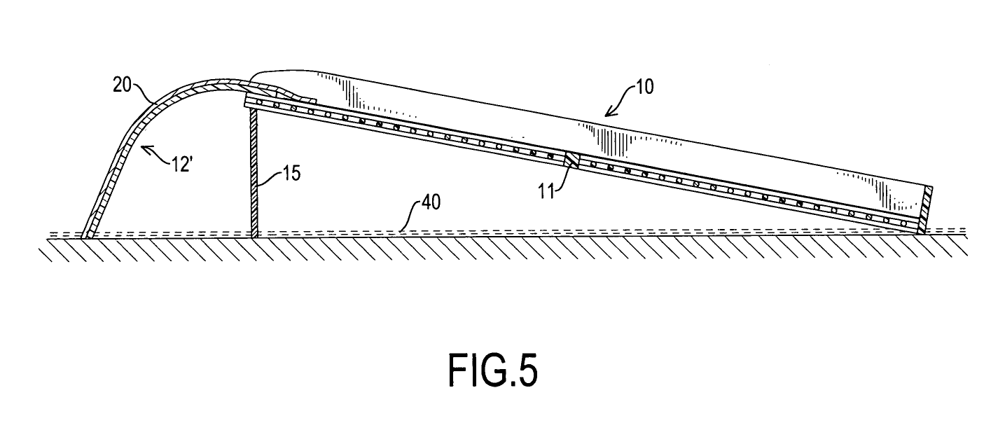

With reference to FIG. 5, a third embodiment of the self-watering breeding in accordance with the present invention has the same design concept with the first embodiment except the gradual slope (11′) has a supporting foot (15) attached under a distal end of the gradual slope (11′) close to the steep slope (12′) to make the gradual slope (11′) erect.

According to the above description, the self-watering breeding device of the present invention has the following advantages:

1. Structure of the self-watering breeding device is quite simple because the device only contains the culturing slide (10) and two absorbent sheets (20, 22). Therefore, manufacturing cost and product cost is extremely low in comparison with the two conventional self-watering breeding devices.

2. All seeds on the gradual slope have enough water for immersion because the water automatically flows down along the gradual slope by gravity to pass the gradual slope all over.

3. The culturing slide (10) in accordance with the present invention allows roots of seeds to extend through the through holes (112) in the gradual slope (11) to absorb water directly, such that the culturing slide (10) can fit with different types of seeds and is versatile in use.

Although the invention has been explained in relation to multiple preferred embodiments, many other possible modifications and variations can be made without departing from the spirit and scope of the invention as hereinafter claimed.

What is claimed is:

1. A self-watering breeding device comprising:
a culturing slide being a bridge with two sides and two ends and having
a gradual slope with one end of the bridge and having multiple through holes defined through the gradual slope and adapted for allowing roots of seeds to extend through the through holes;
a steep slope with the other end of the bridge; and
a guiding arc connected between the gradual slope and the steep slope;
a capillary sheet placed on the steep slope and extending from the end of the steep slope over the guiding arc to the gradual slope;
an immersion sheet placed on the gradual slope to cover the entire gradual slope and partially overlapping with the capillary sheet.

2. The self-watering breeding device as claimed in claim 1, wherein the guiding arc is integrally connected between the steep slope and the gradual slope.

3. The self-watering breeding device as claimed in claim 2, wherein the culturing slide further has
two side boards erectly formed at two sides of bridge;
a bottom board formed at the end at the steep slope; and
two elongated holes defined in the bottom board to drain water.

4. The self-watering breeding device as claimed in claim 3, wherein the culturing slide further has two extending feet respectively formed at the two ends of the culturing slide to raise the culturing slide.

5. The self-watering breeding device as claimed in claim 4, wherein the gradual slope further has a supporting foot attached under the gradual slope to make the gradual slope erect.

6. The self-watering breeding device as claimed in claim 5 further comprising multiple guiding ribs formed over the steep slope and the guiding arc.

7. The self-watering breeding device as claimed in claim 1, wherein the culturing slide further has
two side boards erectly formed at two sides of bridge;
a bottom board formed at the end at the steep slope; and
two elongated holes defined in the bottom board to drain water.

8. The self-watering breeding device as claimed in claim 1, wherein the culturing slide further has two extending feet respectively formed at the two ends of the culturing slide to raise the culturing slide.

9. The self-watering breeding device as claimed in claim 1, wherein the gradual slope further has a supporting foot attached under the gradual slope to make the gradual slope erect.

10. The self-watering breeding device as claimed in claim 1 further comprising multiple guiding ribs formed over the steep slope and the guiding arc.
